(19) United States
(12) Patent Application Publication
(10) Pub. No.: US 2006/0208071 A1
(43) Pub. Date: Sep. 21, 2006

(54) Method of protecting a brand by sale promotion

(75) Inventors: Wei Chang, Hsinchu City (TW); Tun-Nien Hsu, Hsinchu City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/132,217

(22) Filed: May 19, 2005

(30) Foreign Application Priority Data
Mar. 21, 2005 (TW) 94108555

(51) Int. Cl. G06K 15/00; G07G 1/14

(52) U.S. Cl. 235/383; 705/14

(57) ABSTRACT

A method of protecting a brand by sale promotion includes the steps of (a) establishing an identification code of a product into a server by a manufacturer while encoding the identification code into a label of the product, wherein the identification code includes at least an attribute of the product; (b) shipping out the product to a retailer from the manufacturer; (c) enabling the identification code of the tag to be read by a consumer using a reader of the retailer to authenticate the authenticity of the product; (d) sending back the identification code to the server while the server determines the authenticity of the product and perform a prize check process according to the identification code; and (e) analyzing and saving the sale condition of the product.

### 1. FIELD OF THE INVENTION

The present invention relates to a method of protecting a brand by sale promotion, and more particularly, to a method of protecting a brand by using an information carrier as a prize-winning certificate.

### 2. BACKGROUND OF THE INVENTION

Nowadays, illegal use of legitimate companies' brands, trademarks, and product has increased exponentially and become very sophisticated in the process that counterfeit goods are common in the present market. This disturbing trend hurts not only a company's profit margin but also its worldwide brand reputation and could possibly open up issues of product liability among a host of other ills that come from this form of illicit commerce. The images of back alley sale of shoddy quality, knock-off products are a thing of the past. Your brand can be attacked half a world away by a globe-spanning, fully integrated, sophisticated illegal operation that has a distribution network that may rival your own in terms of efficiency and profitability.

Referring to FIG. 1 for a flowchart depicting a distribution channel of a product. In FIG. 1, a brand product is manufactured by the factory of the brand owner manufacturer or by its OEM manufacturer, and then is sold and shipped to its branch companies, general agents or regional agents in different regions of the world. The branch companies, general agents or regional agents have to establish the sale channels in their responsible regions and promote the sale through media. For large-area or highly-populated regions, the branch companies, general agents or regional agents perform the sale further through distributors who can sell their products in retailing stores, and the distributors may sell merchandises of different brands at the same time.

Counterfeit or illegal business models are described as follows:
Case 1: Counterfeit manufacturers illegally sell counterfeit goods to retailing stores through a distributor while the retailing stores sell the counterfeit goods to consumers, as seen in FIG. 1.
Case 2: A brand owner consignees an OEM manufacturer to produce a brand product and the OEM manufacturer sells the extra production, cancelled orders, and defects with a low price through a sale channel. Such conduct relates to a breach of contract entered between the brand owner and the OEM manufacturer, and such conduct not only results in loss of revenue to the companies affected but also but also its worldwide brand reputation is adversely affected
Case 3: A branded company generally will authorize general agents in different countries or regions to sell their products while establishing it worldwide sale channel. The general agents have to pay a loyalty fee, establish a sale channel, advertise and marketing, and build maintenance and repair centers. Therefore, the price offered by the general agents is usually higher than the price offered by the country of origin. Some trading companies buy large quantity of products from the country of origin and sell the products to the distributing areas with a more advantageous price than obtaining a license from the general agent.
Case 4: Brand companies or general agents usually agree with their downstream distributors in different regions or channels to keep the retailing price within a certain specific range, and the price offered by branded companies (or general agents) to downstream distributors is usually lower than the retailing price. With sale promotions, distributors place orders of a large quantity and the selling price is getting lower. The distributors usually order a large quantity of products with a lower price, and if the products cannot be sold out, then the distributors will return the goods to the upstream, or will sell the products with a price lower than the agreed price. Such conduct causes a chaos of prices, and consumers will compare the prices, so that the distributor's retailing price becomes lower, which will affect the overall profitability of the product.

The foregoing anti-counterfeit technology is not more than assigning a unique serial number to each product and saving the number into a central database. After a product is sold, a consumer can read the serial number of the product and check it with the database to see if such serial number exists in the database. If such serial number does not exist, then the product is determined as a counterfeit. If such serial number exists in the database, then the consumer can register the product into the database and marks the product as a sold item. If the serial number was previously registered as a sold item, then the consumer can determine that the purchased product may be a counterfeit.

Patents of the related technology include U.S. Pat. Nos. 4,816,824, 5,818,021 and 6,226,619 and ROC Pat. No. 577031. Although these patents were disclosed, counterfeits and parallel imported products are found all over the market. It is obvious that the foregoing patents cannot substantially overcome the counterfeit issue for the following reasons:
1. Consumers generally do not check the serial number: There are various different types of merchandises bought by consumers, and consumers seldom check whether or not the product is a genuine one through a network. In other words, consumers will not spend time on checking without an incentive reason.
2. The serial number sticker can be a counterfeit as well: As disclosed in U.S. Pat. No. 6,226,619 B1, each product comes with a unique serial number sticker, and such number can be read visually by consumers. The product also comes with a radio frequency identification (RFID) tag, and the ID code in such RFID tag must be read by a RFID reader. The ID code gives the same number as printed on the sticker, so that consumers can distinguish whether or not a product is genuine without going through the central database. This patent has two assumptions, first: that the cost of the RFID tag is high and applicable for a high-price product, so that counterfeiters are unwilling to invest for such cost, and the second that the counterfeiters do not have this technology. However, these two assumptions are not necessarily valid. If the counterfeit is a high-price product, counterfeiters are willing to spend money to copy the identification tools. With the mature RFID tag manufacturing technology, RFID tags not only come with a lower price, but also have an easier way to write the ID code into the RFID tags. Therefore, simply using a RFID tag or a number label on the product cannot protect the product from being copied, without backing up the same with a central database.
3. If a serial number is duplicated, how to distinguish the genuine one? Although consumers do not usually check the product over the network, consumers can easily determine a counterfeit if the serial number cannot be found on the network. If the counterfeiter of the ID encoder knows and intentionally copies the number, then the counterfeit having the same number may be sold first, and the genuine product is treated as a counterfeit. Such mechanism is definitely not acceptable to branded companies.
4. Product information other than the counterfeits is not available: If consumers know about the counterfeit and are still willing to buy the counterfeit with a low price, such mechanism is not valid. In the situations that OEM factories sell a product with a low price, import merchandises by parallel imports, and downstream distributors breach contracts by selling the product below an agreed price, consumers usually can buy brand products and manufacturer's database also contains the record of such ID code. Therefore, branded companies still cannot control this situation, and their sale are affected continuously. Since improper business conducts of this sort exist, downstream distributors and retailing stores are not willing to install product inquiry equipments. If consumers cannot confirm the product from the Internet at the retailing store, it is difficult for consumers to prove the product is a counterfeit bought from a particular retailing store, even when they can confirm the counterfeit from the Internet at home.

Therefore, it urgently requires a method of protecting a brand by sale promotion to overcome the foregoing shortcomings of the prior arts.

### SUMMARY OF THE INVENTION

The primary objective of the present invention is to provide a method of protecting a brand by sale promotion that uses an identification code of a product to integrate with a network and sale promotion to achieve the anti-counterfeit purpose, after-sale maintenance mechanism and sale analysis. The information carrier (RFID tag) for product identification is a voucher for exchanging the sale promotion prizes. This method is used to integrate the extensive consumer power to effectively achieve the anti-counterfeit purpose and timely collect and analyze sale information.

To achieve the foregoing objective, the present invention provides a method of protecting a brand by sale promotion, which comprises the following steps:
(a) establishing an identification code of a product into a server by a manufacturer while encoding the identification code into a label of the product, wherein the identification code includes at least an attribute of the product;
(b) shipping out the product to a retailer from the manufacturer;
(c) enabling the identification code of the tag to be read by a consumer using a reader of the retailer to authenticate the authenticity of the product;
(d) sending back the identification code to the server while the server determines the authenticity of the product and perform a prize check process according to the identification code; and
(e) analyzing and saving the sale condition of the product.

Preferably, step (a) further comprises the following steps:
(a1) attaching a label to the product by the manufacturer, wherein the label has an identification code including at least one attribute of the product;
(a2) reading the identification code of the label by the manufacturer;
(a3) saving the identification code into the server; and
(a4) assigning at least one identification code as the prize winning number by the server.

Preferably, step (c) further comprises the following steps:
(c1) purchasing a product by a consumer;
(c2) reading the identification code of the label using a terminal; and
(c3) connecting the terminal to the server while the identification code is accessible; and displaying a counterfeit signal on the terminal while the identification code is not accessible.

Preferably, step (d) further comprises the following steps:
(d1) recording the identification code, terminal number and date by the server;
(d2) checking whether or not the identification code is contained in the server;
(d3) checking whether or not the identification code is duplicated while the server contains the identification code; and
(d4) performing a prize check while the identification number is not duplicated.

Preferably, Step (e) further comprises the following steps:
(e1) storing personal data of the consumer and data of the product into the server; and
(e2) analyzing and saving the sale situation of the product.

Preferably, step (d) further comprises:
(d3′) recording the product as a counterfeit in the server while the identification code is not contained in the server.

Preferably, Step (d) further comprises:
(d4′) recording the product as a counterfeit in the server while the identification code is duplicated.

Preferably, the label is a RFID tag.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a flowchart of the sale of a product; and

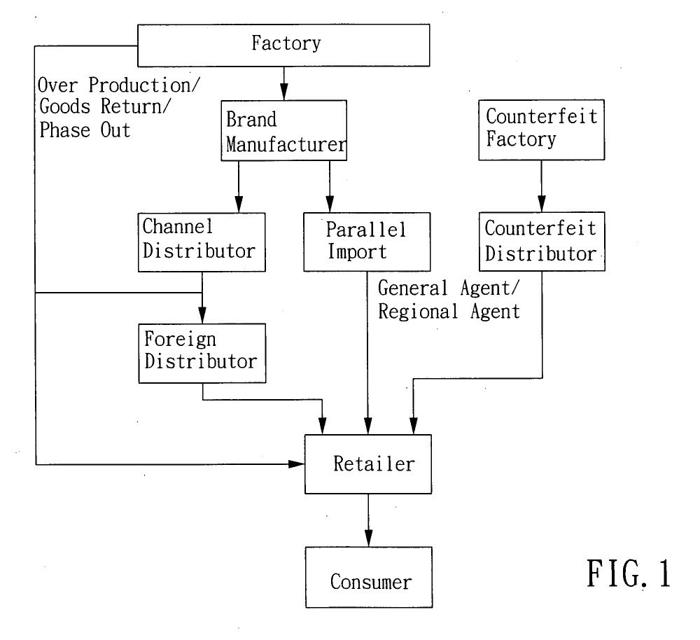

FIG. 2 is a flowchart of the method of protecting a brand by sale promotion in accordance with the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

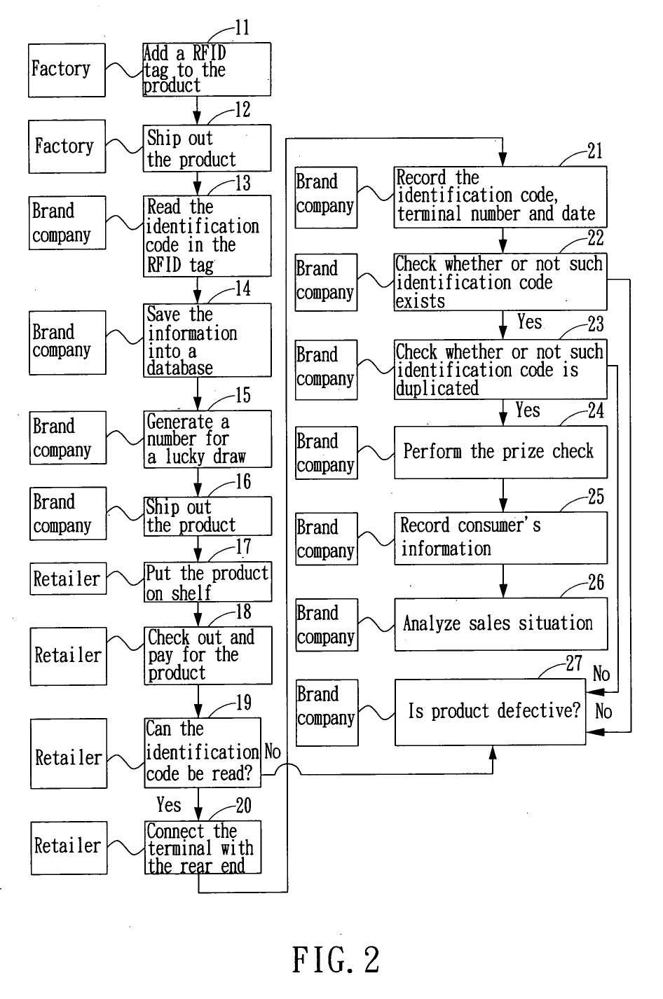

Referring to FIG. 2, a flow chart of the method of protecting a brand by sale promotion in accordance with the present invention is given, wherein:
Step 11: Add a RFID tag to the product. Manufacturers add a RFID tag into the product or other identification device (such as a sealed sticker) onto the product or a package of the product before shipping the product to a branded company or general agent. The RFID tag could be a label having an ID code, or requires a code sent from a reader to the label before the data protected in the label can be read, so as to improve the security of the confidential information.
Step 12: Ship out the product. The factory ships the product to the branded company.
Step 13: Read product identification code. The RFID tag is read by a RFID reader, so that the identification code in the label can be read and written into a “Product Identification Code File” database. As to the sealed sticker, it is necessary for the factory to create a ID code file and import the file into the “Product Identification Code File” database.
Step 14: Save information into a database. The branded company or general agent builds a unique identification code of the RFID tag or other identification device into the database (server) as a ““Product Identification Code File”.
Step 15: Generate a lucky draw number. The branded company generates a prize winner name list by a predetermined lucky draw method according to the identification code database to produce a “Prize Winner Identification Code File”. In the meantime, the sale promotion is introduced by advertising media.
Step 16: Ship out the product. The branded company ships the product to retailers.
Step 17: Put the product on shelf. The retailers display the product.
Step 18: Consumers decide to buy the product and pay for the product.
Step 19: Check whether or not the identification code is readable. Consumers use a RFID reader at a terminal in a store to read the identification code in the RFID tag of the product or remove the paper outside a label to input the identification code of a product into the terminal. The RFID is used for reading the label, so that consumers can immediately discover a counterfeit when the product does not come with a RFID tag. A consumer will not be able to exchange for a gift prize of a cash prize when buying such counterfeits. The method of using labels lets consumers use devices such as a computer, a PDA or a mobile phone to connect to Internet or a rear end information system.
Step 20: Connect the terminal with the rear end. The rear end information system (server) is situated at the branded company, general agent, or collocation network service provider.
Step 21: Record the identification code, terminal number and date. The rear end information system (server) records the registered product identification code, reads the terminal number and the date, and adds them to a “Customer Registration File”.
Step 22: Check whether or not an identification code exists. The rear end information system (server) compares the newly added customer registration information with the “Product Identification Code File”. If a product identification code cannot be found in the “Product Identification Code File”, then an abnormal terminal message such as “This product may be a counterfeit or obtained through an improper channel” is returned, and such message will be recorded into the “Abnormal Record File” database, and the information of the abnormal record includes the product identification code, the terminal number, and the cause of abnormality.
Step 23: Check whether or not the identification code is duplicated. The rear end information system (server) checks whether or not the identification code is duplicated in the “Customer Registration File”. If there is a duplicated number, then such number is recorded in the “Abnormal Record File”. The abnormal record file includes the product identification code, terminal number and cause of abnormality.
Step 24: Perform a prize check. The rear end information system (server) checks whether or not the customer's registered identification codes in the “Prize Winner Identification Code File” have the same identification code of the product. If there is a matched data, then the prize winner information is replied to the front end terminal and printed as a voucher, so that a customer can bring the voucher to a specified location or store to exchange for a gift prize or a cash prize.
Step 25: Record consumer's information. The prize winner can use the terminal at the store, Internet browser, or Internet to connect to the server, input related personal data, and check the purchase price and product identification code. The rear end information system adds such data into the “Prize Winner Data File” database.
Step 26: Analyze sale situation. The rear end information system analyzes the “Customer Registration File” and the “Prize Winner Data File” in the database for conducting related sale analysis and preparing production and sale strategies.
Step 27: Abnormal Product. The branded company keeps tracks on the cause of abnormality and investigates counterfeits or illegitimate sale channel according to the abnormal record file and the store where the related terminal is located.

In the present invention, the label is preferably a RFID tag or a sticker with a sealed ID number. The label can be integrated with the product or attached onto the product or attached onto a package of the product. If a RFID tag is used, the RFID tag can be torn to destroy the antenna thereof so as to disable the interrogation function. In addition, the tag can be the one having an identification code accessible to any common reader or the one with a security function that require a password to be sent from a reader before accessing the data reside therein.

Further, the customer's registered product identification code, purchase data and customer information can be used as the information for the maintenance of the product. The purchase date registered at the rear end information system (server) is used as a starting date for the product warranty, which can save tremendous time and effort for handling the customer warranty and maintenance information.

In summation of the description above, the present invention uses a sale promotion method to integrate a unique identification code to effectively prevent counterfeits by the extensive customer power, and further to control the situation of sale channels, so as to collect and analyze the information about sale and product life cycles.

What is claimed is:

1. A method for protecting a brand by sale promotion, comprising the steps of:
(a) establishing an identification code of a product into a server by a manufacturer while encoding the identification code into a label of the product, wherein the identification code includes at least an attribute of the product;
(b) shipping out the product to a retailer from the manufacturer;
(c) enabling the identification code of the tag to be read by a consumer using a reader of the retailer to authenticate the authenticity of the product;
(d) sending back the identification code to the server while the server determines the authenticity of the product and perform a prize check process according to the identification code; and
(e) analyzing and saving the sale condition of the product.

2. The method of protecting a brand by sale promotion of claim 1, wherein the step (a) further comprising the step of:
(a1) attaching a label to the product by the manufacturer, wherein the label has an identification code including at least one attribute of the product;
(a2) reading the identification code of the label by the manufacturer;
(a3) saving the identification code into the server; and
(a4) assigning at least one identification code as the prize winning number by the server.

3. The method of protecting a brand by sale promotion of claim 1, wherein the step (c) further comprising the step of:
(c1) purchasing a product by a consumer;
(c2) reading the identification code of the label using a terminal; and
(c3) connecting the terminal to the server while the identification code is accessible; and displaying a counterfeit signal on the terminal while the identification code is not accessible.

4. The method of protecting a brand by sale promotion of claim 1, wherein the step (d) further comprising the step of:
(d1) recording the identification code, a terminal number and a date by the server;
(d2) checking whether or not the identification code is contained in the server;
(d3) checking whether or not the identification code is duplicated while the server contains the identification code; and
(d4) performing a prize check while the identification number is not duplicated.

5. The method of protecting a brand by sale promotion of claim 1, wherein the step (e) further comprising the step of:
(e1) storing personal data of the consumer and data of the product into the server; and
(e2) analyzing and saving the sale situation of the product.

6. The method of protecting a brand by sale promotion of claim 4, wherein the step (d) further comprises:
(d3′) recording the product as a counterfeit in the server while the identification code is not contained in the server.

7. The method of protecting a brand by sale promotion of claim 4, wherein the step (d) further comprises:
(d4′) recording the product as a counterfeit in the server while the identification code is duplicated.

8. The method of protecting a brand by sale promotion of claim 1, wherein the label is a RFID tag.
